(19) United States
(12) Patent Application Publication
(10) Pub. No.: US 2004/0042234 A1
(43) Pub. Date: Mar. 4, 2004

(54) Backlight device

(75) Inventor: Tetsushi Otake, Tsurugashima-Shi (JP)

Correspondence Address: PILLSBURY WINTHROP, LLP, P.O. BOX 10500, MCLEAN, VA, 22102, US

(73) Assignee: TOKO KABUSHIKI KAISHA, Tokyo-To (JP)

(21) Appl. No.: 10/649,607

(22) Filed: Aug. 28, 2003

(30) Foreign Application Priority Data
Aug. 30, 2002 (JP) 2002-253155

(51) Int. Cl. F21V 7/04

(52) U.S. Cl. 362/561; 362/31

(57) ABSTRACT

A backlight device obtains white light by mixing and synthesizing the three primary colors, the white light appearing as bright to the human eye as conventional white light; in addition, the backlight device is highly economical, in that it reduces power consumption by reducing the effective power input to the light-emitting diodes, and lengthens the lives of the light-emitting diodes.

In a backlight device comprising self-luminous-sources in the colors of red, green, and blue, the device mixing and synthesizing the three primary colors from the self-luminous sources into white light, in order to light a liquid crystal display device using a light-conducting plate and/or a light-scattering plate, the self-luminous-sources of the three primary colors are illuminated sequentially at different timings for each color, so that the light-generating timings partially overlap, achieving time-division light-emission.

### BACKGROUND OF THE INVENTION

1. Field of the Invention

This invention relates to a liquid crystal display device, and more particularly relates to a backlight device, which is used for illuminating the liquid crystal display device, and provides a white light source comprised by mixing and synthesizing self-generated lights in the three primary colors.

2. Description of Related Art

Recently, the proliferation of OA apparatuses, such as personal computers, has led to an increased need for portable OA apparatuses, which can be used in the office and outdoors, and increased demands to make such apparatuses smaller and lighter. A liquid crystal display device is widely used as one way of achieving these objects. Liquid crystal display devices can easily be made small and light, and are essential in reducing power consumption of battery-driven portable OA apparatuses.

Liquid crystal display devices are broadly classified into reflective types and permeable types.

In reflective types, a light beam is radiated onto the top face of a liquid crystal panel, and is reflected by the bottom face; the reflected light is used to visually identify the image. In permeable types, the image is visually identified by using light which has passed from a light source (backlight) provided on the bottom face of the liquid crystal panel.

Since reflective types are inexpensive, there are widely used as single-color (e.g. black and white displays and the like) display devices in calculators, watches, and the like. However, the amount of reflected light varies according to environmental conditions, resulting in poor visual identification. For this reason, reflective types are unsuitable as multicolor or full color displays in personal computers and the like. Therefore, permeable types are generally used as display devices in multicolor or full color displays in personal computers and the like.

Conventional permeable liquid crystal display devices use a white backlight, and realizes the multicolor and full color displays by selectively passing the white light through a filter of the three primary colors.

A cold cathode fluorescent tube (CCFL) is generally used as the white light source, but a backlight device using a light-emitting diode (LED) is nowadays being used in portable devices in view of being small, thin, and having low energy consumption.

FIG. 3 is a schematic diagram showing an example of the constitution of a color filter liquid crystal device, which uses LEDs as a light source. FIG. 4 is a cross-sectional view illustrating the liquid crystal display device.

In FIG. 4, a light-polarizing plate 4, a glass substrate 5, a communal electrode 6, an alignment layer 7, a liquid crystal layer 8, a spacer 9, an alignment layer 10, a pixel electrode 11, a glass substrate 15 having a color filter, a light-polarizing plate 16, a light-scattering plate 17, and a light-conducting plate 18, are laminated sequentially from top to bottom, and form a liquid crystal panel 1. The alignment layer 10 is provided on the top face of the pixel electrode 11 on the glass substrate 15, the alignment layer 7 is provided on the bottom face of the communal electrode 6, and a liquid crystal substance is filled in the gap of the spacer 9 between the alignment layers.

As shown in FIG. 3, a color filter is provided on the glass substrate 15, and the pixel electrodes 11, which correspond to the individual display pixels (liquid crystal cells) arranged in a matrix, is provided on top of the glass substrate 15. Each individual pixel electrodes 11 is switched ON and OFF by a TFT 12. Each individual TFT 12 is actively driven by selectively switching a tracking line 13 and a signal line 14 of a liquid crystal drive circuit 20 ON and OFF. An LED unit 3 using a plurality of LEDs protrudes from one side of the light-conducting plate 18 below the light-scattering plate 17 at the bottom side of the light-polarizing plate 16, and comprises a light-emitting diode which emits the three primary colors red (R), green (G), and blue (B). The light-conducting plate 18 comprising the light-scattering plate 17, the LED unit 3, and the LED drive circuit 21 together comprise a backlight device 2.

FIG. 5 is a circuit diagram schematically showing the backlight device.

As shown in FIG. 5, the LED unit 3 comprises LEDs which emit lights of the three primary colors (i.e. red (R), green (G), and blue (B)) to the light-conducting plate 18. The light-conducting plate 18 obtains white light by leading away and synthesizing the lights from the LEDs of the LED unit 3. The light-scattering plate 17 is providing in a single piece with the light-conducting plate 18, and scatters the light evenly over the entire face of the liquid crystal panel 1, forming the backlight (white light source) of the liquid crystal display device.

As shown in FIG. 5, the backlight device for obtaining white light by synthesizing the three primary colors R, G, and B, is driven by a constant-current power supply which uses the LED drive circuit 21 to drive the colors red (R), green (G), and blue (B) of the LED unit 3. Vcc represents the power supply.

According to this method, when IL represents the current input to each LED and the Vf represents the drop voltage in the sequence direction of the LEDs, the power PL input to each LED is calculated by PL=IL×Vf. Power Pr (=PL−Po) is obtained by subtracting the light-emission energy Po from the input power PL, and represents the heat loss in the LED; this heat loss shortens the life of each LED, and thermal destruction may reduce the brightness.

### SUMMARY OF THE INVENTION

This invention has been realized after consideration of the circumstances described above, and aims to provide a backlight device which obtains white light by mixing and synthesizing the three primary colors RGB, the white light appearing as bright to the human eye as conventional white light, and the backlight device being highly economical, in that it reduces power consumption by reducing the effective power input to the light-emitting diodes, and lengthens the lives of the light-emitting diodes.

In order to achieve the above objects, this invention provides a backlight device for lighting a liquid crystal display device, comprising self-luminous light-sources in primary colors of red, green, and blue, the three primary colors from the self-luminous light-sources being mixed and synthesized into white light; and a light-conducting plate and/or a light-scattering plate. The self-luminous light-sources of the three primary colors are illuminated sequentially at different timings for each color, and in such a manner that the light-generating timings partially overlap, achieving time-division light-emission.

The backlight device is characterized in using light-emitting diodes as the self-luminous light-sources of the three primary colors. Moreover, phosphor for generating light by light-absorption is provided to the light-conducting plate and/or the light-scattering plate.

The backlight device of this invention uses light-emitting diodes which self-generate light in the three primary colors of red (R), green (G), and blue (B), and obtains white light by mixing and synthesizing the three primary colors. The light is led to the liquid crystal display device by using the light-conducting plate and/or the light-scattering plate. The effective power is reduced by sequentially illuminating the light-emitting diodes at deviated timings. In addition, time division light-emission, in which parts of the light-emission times of the colors overlaps, prevents the light from appearing less bright to the human eye.

Further, the light-conducting plate and/or the light-scattering plate is/are provided with phosphor for generating light by light-absorption, preventing any reduction in the brightness of the light.

### BRIEF DESCRIPTION OF THE DRAWINGS

FIG. 1 is a cross-sectional view of the constitution of a liquid crystal display device using the backlight device according to the embodiment of this invention;

FIG. 2A is a schematic circuit diagram of the backlight device of this invention, and FIG. 2B is a timing chart of the same;

FIG. 3 is an exploded perspective view of a liquid crystal display device using a conventional backlight device;

FIG. 4 is a cross-sectional view of a liquid crystal display device using a conventional backlight device; and

FIG. 5 is a schematic circuit diagram of a conventional backlight device.

### DETAILED DESCRIPTION OF A PREFERRED EMBODIMENT OF THE INVENTION

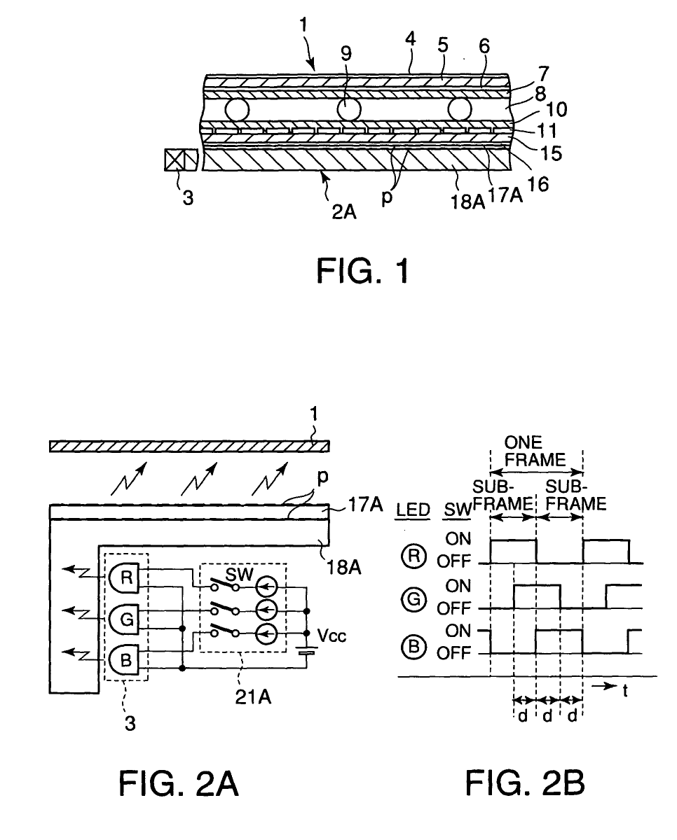

A backlight device according to an embodiment of this invention will be explained based on FIG. 1, FIG. 2A, and FIG. 2B.

FIG. 1 is a cross-sectional view of the constitution of a liquid crystal display device using the backlight device according to the embodiment of this invention.

As shown in FIG. 1, a light-polarizing plate 4, a glass substrate 5, a communal electrode 6, an alignment layer 7, a liquid crystal layer 8, a spacer 9, an alignment layer 10, a pixel electrode 11, a glass substrate 15 having a color filter, and a light-polarizing plate 16, are laminated sequentially from top to bottom, and together comprise a liquid crystal panel 1.

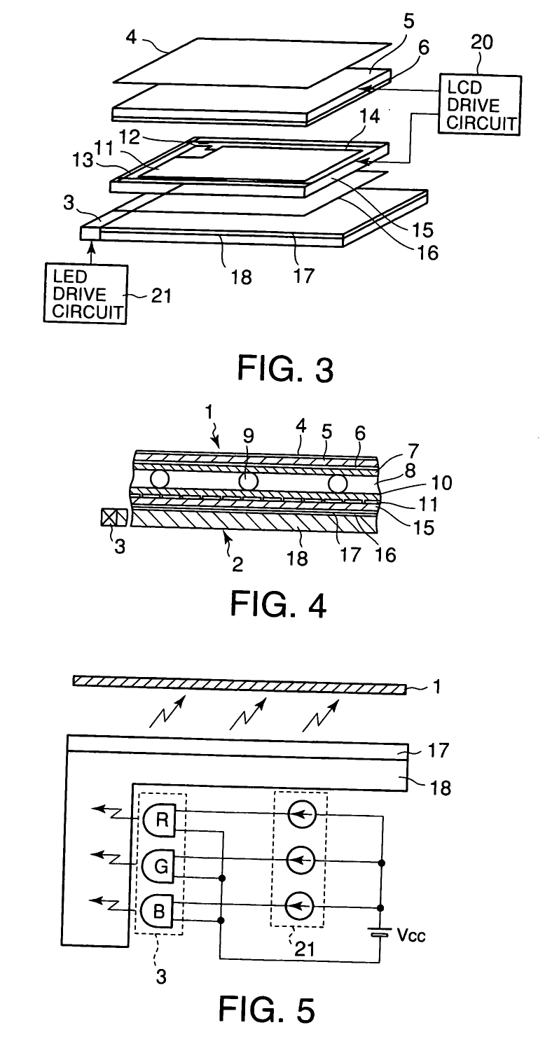

The backlight device 2A of this invention comprises phosphor p, provided on top of a light-scattering plate 17A and a light-conducting plate 18A, and an LED unit 3 and an unillustrated LED drive circuit. Parts, which are the same as those in FIGS. 3 and 4, are represented by the same reference codes.

FIG. 2A shows a method for driving the backlight device of this invention, and FIG. 2B is a timing chart of the method.

FIG. 2A is a schematic circuit diagram showing the backlight device of this invention using a light-scattering plate and a light-conducting plate comprising phosphor, and FIG. 2B is a timing chart for illustrating the light-emitting timings which the LEDs are sequentially illuminated at.

As shown in FIG. 2A, reference code 17A represents a light-scattering plate comprising the phosphor p, 18A represents a light-conducting plate comprising the phosphor p, 3 represents the LED unit using light-emitting diodes which generate the colors R, G, and B, 21A represents a drive circuit which generates a constant-current power supply and a switch SW for sequentially illuminating the LEDs, and Vcc represents the supply power.

The switch SW cyclically illuminates the LEDs (R, G, and B) of the LED unit 3 in sequence, ensuring that the illumination times of two of the LEDs overlap in part. By continuously illuminating the R, G, and B LEDs in cycles, the red, green, and blue lights are mixed and synthesized into white light; furthermore, the light-scattering plate and a light-conducting plate comprising phosphor achieve a white light which has no loss of brightness as viewed by the human eye.

Subsequently, the timings which the LEDs are sequentially illuminated at will be explained using the timing chart of FIG. 2B.

In FIG. 2B, the horizontal axis shows the time t, and the vertical axis shows the ON and OFF switchings of the colors R, G, and B of the LEDs.

For instance, when one frame is 1/60 of a second (one cycle), and the time during which two LEDs partially overlap is 50%, the sub-frame (sub-cycle) for R, G, and B will be exactly half the length of one frame, that is, 1/120 of second.

R, G, and B are illuminated as follows.

Illumination of R LED: at the SW of R, the first sub-frame is ON, and the subsequent sub-frame is OFF.

Then, illumination of G LED: G switches ON after half a sub-frame has elapsed since R switched ON, and G switches OFF one sub-frame later.

then, illumination of B LED: B switches ON (when R has switched OFF) after half a sub-frame has elapsed since G switched ON, and B switches OFF one sub-frame later.

In this way, the starts of the illuminations of R, G, and B are driven at time intervals of half sub-frames, so that the illumination time of each LED is one sub-frame.

As a result, when the overlap time between the illuminated R, G, and B is 50%, the power consumed is half that in conventional devices, and the heat loss of the overall LED is half the conventional amount.

Incidentally, when the time d during which the LEDs overlap is zero (d=0), the illumination time (sub-frame) of each color is exactly one-third of one frame. One-third of the power is therefore consumed; however, due to deviation in the timings of the light switches, the white light obtained by synthesizing the colors may be slightly grey, rather than pure white, and its brightness may be diminished.

The overlap times (d) of part of the lights emitted from the LEDs are adjusted by continuously illuminating the R, G, and B LEDs of the LED unit 3 in cycles in this way.

The overlap time between the color illuminations is ideally 50%, but it should preferably be set in balance with the power consumption. One frame (cycle) is set in consideration with the light-accumulating time of the phosphor such as the light-conducting plate, the light-scattering plate, and the like, and should be shorter than the light-accumulating time.

The backlight device of this invention is not limited to the embodiments described above. For example, an underneath backlight may be used instead of the sidelight system backlight described in the above embodiments. Furthermore, the underneath backlight may be used as the face-emitted light using organic EL as the self-luminous source. Moreover, a light-accumulating phosphor may be pasted over the light-conducting plate and the light-scattering plate, and they may be provided in the shape of a film. One or multiple light-accumulating phosphor having differing degrees of color absorption may be provided in correspondence with the brightness of the colored lights from the self-luminous source, ensuring balance between the colors.

As described above, the backlight device of this invention obtains white light by mixing and synthesizing lights in the three primary colors of red (R), green (G), and blue (B), sequentially illuminates the light-emitting diodes at deviated timings, and overlaps parts of the times when the light-emitting diodes are emitting the lights, thereby achieving time-division light-emission so that the brightness of the white light is no different from conventional light as viewed by the human eye; in addition, this invention reduces power consumption by reducing the effective power input to the light-emitting diodes, and extends the lives of the light-emitting diodes.

What is claimed is:

1. A backlight device for lighting a liquid crystal display device, comprising:
self-luminous sources in primary colors of red, green, and blue, the three primary colors from the self-luminous sources being mixed and synthesized into white light; and
a light-conducting plate and/or a light-scattering plate;
the self-luminous sources of the three primary colors being illuminated sequentially at different timings for each color and so that the light-generating timings partially overlap, thereby achieving time-division light-emission.

2. The backlight device according to claim 1, wherein light-emitting diodes are used as the self-luminous sources of the three primary colors.

3. The backlight device according to claim 1, wherein a fluorescent body for generating light by light-absorption is provided to the light-conducting plate and/or the light-scattering plate.

4. The backlight device according to claim 3, wherein the phosphor comprises a light-accumulating fluorescent body or long-residual light phosphor.
